(19) United States
(12) Patent Application Publication
(10) Pub. No.: US 2026/0300965 A1
(43) Pub. Date: Oct. 1, 2026

(54) DELEGATE MODEL FOR BLOCKCHAIN TRANSACTIONS

(71) Applicant: HSBC SOFTWARE DEVELOPMENT (GUANGDONG) LIMITED, Guangzhou (CN)

(72) Inventors: Wei Ming ZHUANG, Guangzhou (CN); Yong XIA, Guangzhou (CN)

(21) Appl. No.: 18/880,543

(22) PCT Filed: Feb. 27, 2023
(86) PCT No.: PCT/CN2023/078548

§ 371 Date: Dec. 31, 2024

(30) Foreign Application Priority Data
Jul. 11, 2022 (CN) 202210814985.6

(51) Int. Cl. G06Q 20/38; G06Q 20/36

(52) U.S. Cl. CPC G06Q 20/389; G06Q 20/367

(57) ABSTRACT

A blockchain transaction system for transferring blockchain tokens from source addresses to custodian entities is disclosed. The system is provided on a blockchain that implements one or more token smart contracts for managing one or more token types. The system comprises a delegate smart contract implemented on the blockchain identified by a delegate address, which includes one or more delegate transfer functions for transferring tokens from a source address to custodian entities, and a plurality of custody smart contracts implemented on the blockchain, each custody smart contract corresponding to a custodian entity and identified by a custodian address. The delegate smart contract is configured to process, using a delegate transfer function, a plurality of transfer requests to transfer custody of tokens of the given token type from a source address associated with a token holder to respective different custodian entities specified by respective custodian addresses. The plurality of transfers are performed in accordance with an approval configured at the token smart contract associated with the given token type, the approval granting token transfer approval by the source address to the delegate address associated with the delegate smart contract.

### FIELD OF THE INVENTION

The invention relates to transaction processing in distributed ledger systems, for example blockchain systems.

### BACKGROUND OF THE INVENTION

Blockchain systems are widely used for transactions of digital assets, such as cryptocurrency and non-fungible tokens. A variety of transaction processing systems, e-wallet systems and the like have arisen to support increasing activity and transaction volumes and support users in managing their digital assets and transactions. For example, a transaction processing system may act as a custodian for asset tokens owned by a user and allow the user to perform transactions. However, while convenient, such systems can add complexity, for example in moving asset tokens into a service provider's custody, which requires additional operations. This additional management overhead is exacerbated by the fact that blockchain transactions are generally very slow and computationally expensive compared to conventional centralised transaction processing architectures.

### SUMMARY OF THE INVENTION

The invention seeks to provide improvements to existing transaction processing approaches. Aspects of the invention are set out in the independent claims. Certain preferred features are set out in the dependent claims.

Disclosed herein is a blockchain transaction system for transferring blockchain tokens from source addresses to custodian entities, provided on a blockchain that implements one or more token smart contracts for managing one or more token types, the system comprising:
a delegate smart contract implemented on the blockchain identified by a delegate address, and comprising one or more delegate transfer functions for transferring tokens from a source address to custodian entities;
a plurality of custody smart contracts implemented on the blockchain, each custody smart contract corresponding to a custodian entity and identified by a custodian address;
wherein the delegate smart contract is configured to process, using a delegate transfer function, a plurality of transfer requests to transfer custody of tokens of the given token type from a source address associated with a token holder to respective different custodian entities specified by respective custodian addresses; and
wherein the plurality of transfers are performed in accordance with an approval configured at the token smart contract associated with the given token type, the approval granting token transfer approval by the source address to the delegate address associated with the delegate smart contract.

In particular, the plurality of transfers are preferably performed in accordance with the same approval, or more specifically in accordance with an approval configured by the token holder in a single approval operation, such that the token holder performs a single approval at the token contract and the multiple transfers are then performed based on the single approval without requiring separate approvals for each custodian address targeted by a transfer.

A token transfer approval may also be referred to as a “spending approval”, and grants to a blockchain address/identity permission to transfer (“spend”) tokens of a token holder (identified by a source address) on behalf of the token holder, for example for a maximum token value (an “allowance”) for fungible tokens or one or more specific identified unitary tokens for non-fungible tokens. Preferably, the system is configured to process, by the token smart contract for the given token type, an approval request for the given token type, the approval request specifying the source address of the token holder and the delegate address for the delegate smart contract as the approved address.

The delegate smart contract is preferably configured to process a plurality of requests to transfer custody of tokens of a second token type from the source address to respective custodian entities associated with respective custodian addresses based on a second token transfer approval granted to the delegate address for the delegate smart contract by the source address. The second approval may be processed by a token contract for the second token type, in the manner set out above.

The, or each, token transfer approval preferably specifies an approved token quantity (e.g. for a value token) or one or more approved token identifiers (for a unitary token type).

Preferably, the delegate transfer function is configured, for each transfer, to invoke a transfer function of the token smart contract for the given token type to perform the transfer to the respective custodian address.

The tokens being transferred may comprise one or more of: a fungible or value token, wherein a transfer of a value or fungible token is associated with a value quantity of the token to be transferred; a non-fungible or unitary token, wherein a transfer of a non-fungible or unitary token is associated with a token identifier of a token to be transferred; and a multi-token bundle comprising a plurality of fungible and/or non-fungible tokens.

More generally, any reference herein to tokens may include value tokens/fungible tokens, where token transfers preferably involve transferring a certain amount of token value, and/or unitary tokens/non-fungible tokens, where token transfers may involve transferring one or more distinct unitary tokens (e.g. identified by token identifiers). Tokens may also comprise multi-token bundles of value and/or unitary tokens. Tokens of any such type may also be referred to as token assets, and a transfer of one or more token asset(s) may involve any such token types.

Where the given token type is a multi-token bundle, each transfer request may specify a plurality of tokens or token values to be transferred to a respective custodian address in a batch transfer. The delegate smart contract is then preferably configured to invoke a batch transfer function of the token smart contract for the token bundle. The multi-token bundle may be an ERC1155 token bundle (e.g. managed by an ERC1155 compliant token contract).

Preferably, the delegate smart contract comprises a plurality of delegate transfer functions, each supporting transfer of a respective class of tokens. One or more of the delegate transfer functions may each process transfers of tokens of a respective token standard. The delegate contract may include respective delegate transfer functions for one or more of (or each of): ERC20 compatible tokens; ERC721 compatible tokens; ERC1155 compatible token bundles; Ether tokens (i.e. Ether cryptocurrency values).

Preferably, the delegate transfer function is configured, for each transfer to a respective custodian address, to query the custodian smart contract at the custodian address to determine whether the custodian smart contract can accept the transfer, and to perform the transfer in dependence on the determination. The custodian smart contract is preferably configured to determine whether the transfer can be accepted based on one or more of: the token type, a transfer value; and/or the source address for the transfer; and to return a query response indicating the determination.

The custodian smart contract may comprise one or more acceptance functions, each acceptance function configured to: receive a query specifying one or more parameters including one or more of: a source address, a token contract address, and a transfer value; determine whether the transfer can be accepted based on the one or more parameters; and return a determination result. One or more or preferably each custodian contract may include respective acceptance functions for one or more of: ERC20 compatible tokens; ERC721 compatible tokens; ERC1155 compatible token bundles; and Ether tokens.

The delegate transfer function is preferably configured to check that the custodian address specified for a transfer corresponds to a smart contract on the blockchain and/or corresponds to one of a set of predetermined custodian contracts (or custodian addresses), and to perform the transfer to the custodian address only in response to a positive determination.

Also disclosed is a method of performing transactions comprising:
receiving, by a delegate smart contract of the blockchain, a request to transfer custody of one or more token assets from a source address to a custodian entity;
querying, by the delegate smart contract, a custody smart contract associated with the custodian entity to determine if the transfer can be accepted by the custody smart contract; and
invoking, by the delegate smart contract, in response to determining that the transfer can be accepted, a transfer function of a token contract associated with the one or more token assets to transfer the one or more token assets to the custodian entity.

The one or more token assets may comprise one or more of: at least one token amount of a value token or fungible token; at least one unitary or non-fungible token; a bundle of value tokens and/or unitary tokens.

Preferably, the request specifies the source address of a token holder of the token assets and a custodian address of the custodian entity, and further specifies one or more token amounts and/or token identifiers.

The querying preferably comprises invoking a function of the custody smart contract, the function configured to determine if the transfer can be accepted.

Preferably, the one or more token assets are transferred in accordance with a transfer allowance granted to the delegate smart contract by the source address, the transfer allowance optionally configured at the token contract by the token holder. The method may comprise receiving and processing multiple requests to transfer token assets associated with the token contract to a plurality of custodian entities based on the transfer allowance.

The method in this example may be configured to perform the steps performed by a system set out previously.

The disclosure also encompasses a system having means, optionally comprising one or more processors with associated memory, for performing any method as set out herein, and one or more computer programs or computer readable media comprising software code which when executed in a data processing system causes the data processing system to implement a system as set out herein or to perform any method as set herein.

Any feature in one example or embodiment may be applied to other examples or embodiments, in any appropriate combination. For example, method features may be applied to described systems, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

### BRIEF DESCRIPTION OF THE FIGURES

FIG. 1 illustrates transfer of blockchain tokens to a custodian addresses;

FIGS. 2A-2B illustrate blockchain transactions for transferring tokens to targets on a blockchain;

FIGS. 2C-2D illustrate transactions mediated by a delegate smart contract;

FIGS. 3A-3B illustrate processing steps for transactions mediated by a delegate smart contract;

FIG. 4 illustrates implementation details of a delegate custody transaction model;

FIG. 5 illustrates a process for transferring a token to a custody address by the delegate smart contract;

FIG. 6 illustrates a system implementing the described delegate transaction model; and

FIG. 7 illustrates a processing device for implementing described techniques.

### DETAILED DESCRIPTION

Embodiments of the invention provide a system for efficient management of blockchain transactions. The system can reduce the communication overhead when transferring blockchain tokens to custodian entities. The tokens may be value tokens such as electronic currency tokens or other tokens representing digital or real-world assets, such as non-fungible tokens. The following embodiments will be described in the context of the Ethereum blockchain. However, the described approach can be applied to other types of blockchain and distributed ledger systems.

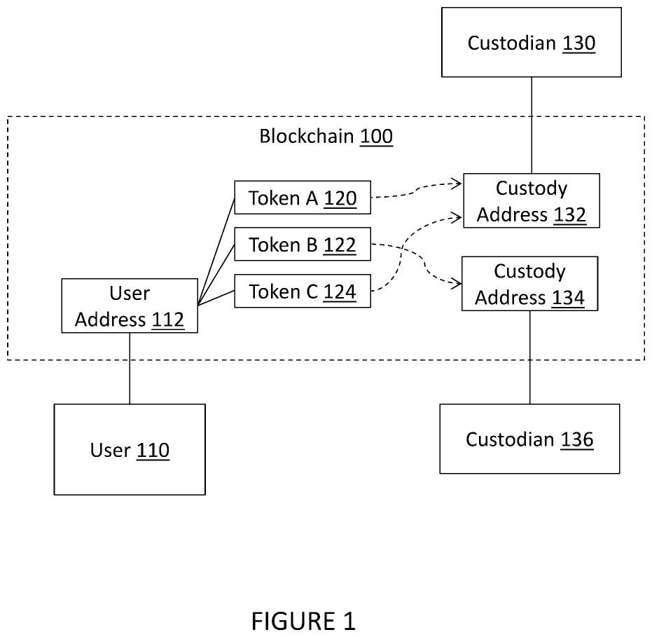

FIG. 1 illustrates by way of example a scenario in which tokens are to be transferred to various custodian addresses by way of blockchain transactions.

In the depicted scenario, a user 110 is associated with a user address or identity 112 on Ethereum blockchain 100. The user owns a set of tokens, including Token A 120, Token B 122 and Token C 124, which are associated with the user's address 112 on the blockchain, identifying the user as the owner or holder of those tokens. The user wishes to transfer these tokens 120, 122, 124 to custodian entities 130, 136, represented in the blockchain by a custodian addresses 132 and 134. The custodian entity, could, for example, be a cryptocurrency service provider that can hold, buy and sell cryptocurrency (in the form of tokens) for a user, such as a cryptocurrency investment platform or the like.

Tokens on the blockchain are managed by one or more token smart contracts, with different token smart contracts managing different token types. Each token smart contract is identified by a smart contract address. Transfers of tokens are effected by invoking transfer functions of the relevant token contracts by the user address of the token holder. For many token types (such as ERC20 and ERC721 compatible tokens), a user may also call an “approve” function to set a spending allowance that permits another address (the approved address) to perform transactions to “spend” (transfer) tokens held by the user, up to a certain approved value (the allowance).

One approach for transferring tokens to custodian addresses involves using a custodian smart contract to manage the transfers. In this approach, users have to first approve the custodian smart contract for each token to be transferred for each custodian so that the custodian smart contract for each custodian is able to “spend” the token (i.e. transfer it on behalf of the user). Then users may send a second transaction for each token to ask the custodian to send the token to the custodian address.

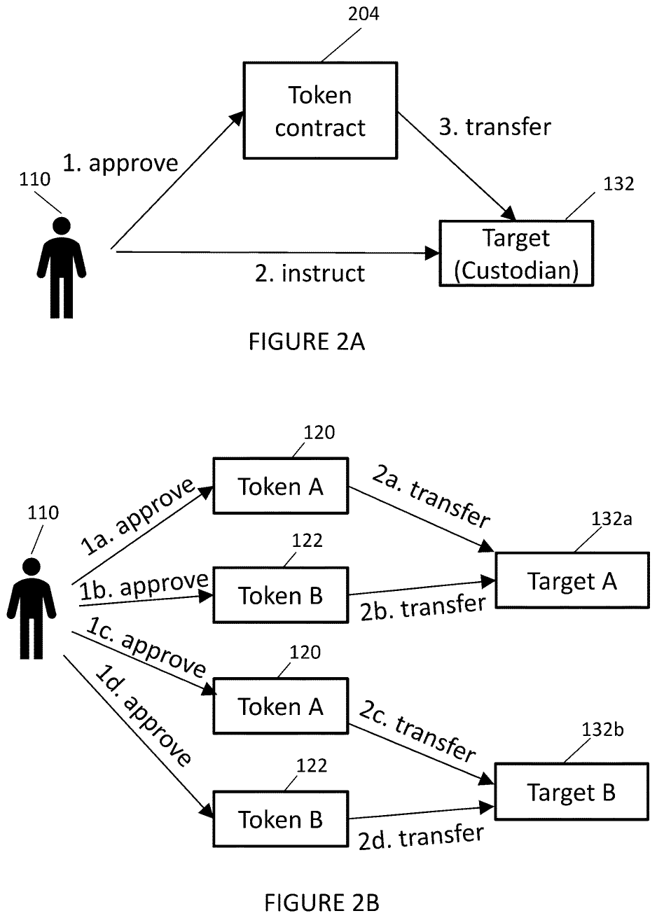

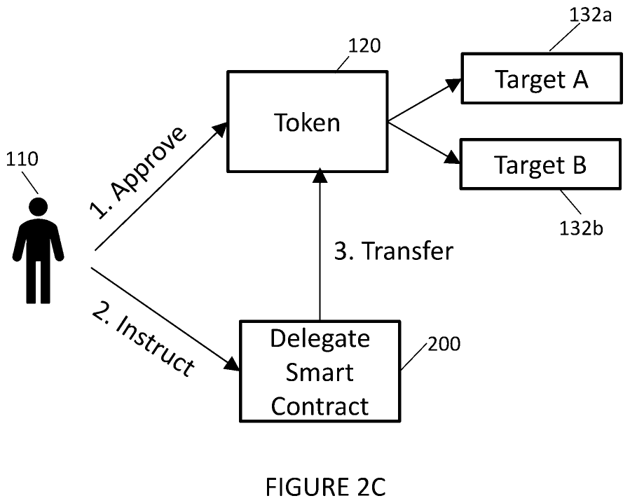

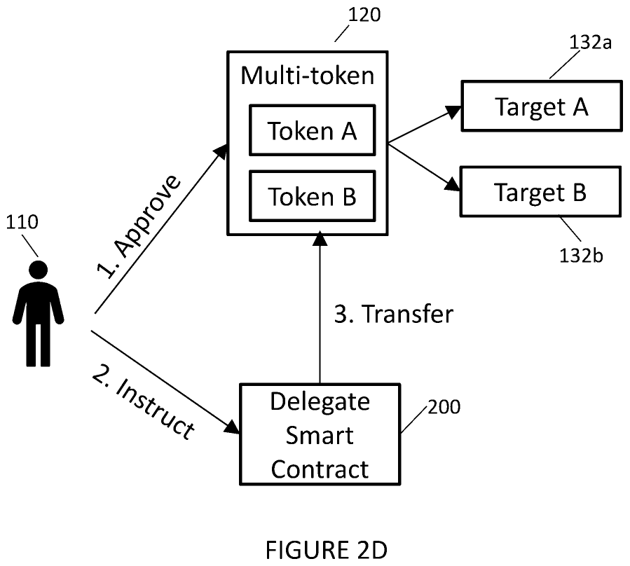

This approach is illustrated in FIGS. 2A-2B. FIG. 2A illustrates a single transaction, in which a user calls an approval function (step 1) of the token smart contract of a particular token, specifying the custodian address of the custodian entity 132 and a token amount that indicates the allowance for that custodian address, i.e. the amount of the user's tokens the custodian may “spend” on the user's behalf. This may, for example, be the “approve” function of an ERC20 token contract or similar. In step 2, the user can then instruct the custodian (by any suitable means, e.g. a web interface provided by the custodian) to transfer a certain value of the token to its custodian address. In step 3, the custodian calls a transfer function of the token contract to make the transfer. This may, for example, be the “transferFrom” function of an ERC20 token contract or similar, which allows specification of the source (in this case the address 112 for user 110) and the transfer amount. As long as the transfer amount is less than or equal to the current allowance of the custodian, the transfer will be successful based on the prior approval.

The instruction to transfer in step 2 may of course be implicit or given in advance rather than on a transaction-by-transaction basis (e.g. this could be a regular payment transaction), as long as the transfer amount is within the current allowance. When a transfer is made, the token contract 204 reduces the allowance for the custodian 130 (or specifically, the custody address 132) by the amount of the transfer, as set by the initial approval. If a transfer exceeds the current allowance it will fail, at which point the user will need to make a further call to the approve function to set a new allowance.

This approach can be used, for example, for transferring tokens according in the ERC20 or ERC721 token standard, or the ERC1155 token standard, or any other token type that allows a token owner to set a spending allowance for another entity. Note that for unitary (non-fungible) tokens managed by an ERC721 or ERC1155 contract, the allowance and/or transfer amounts may always (implicitly or explicitly) equal one, and allowances/transfers may specify particular token identifiers (token ID) to which an approval/transfer relates.

In practice, a user may use tokens of multiple token types and may wish to transfer tokens to more than one target (custodian). However, this can result in large numbers of operations. This is illustrated in FIG. 2B which shows a user transferring tokens of two types (Token A and Token B) to two target custodians, Target A 132a and Target B 132b.

As discussed above, assuming ERC20 type tokens, each token transfer involves two stages:
Stage 1—Approval—the user 110 approves the custodian address to spend a given quantity of token X by calling the approve function of the ERC20 smart contract for token X with the custodian address and quantity as parameters—see operations 1a, 1b, 1c and 1d in FIG. 2B.
Stage 2—Transfer—the custodian performs a transfer operation for the given quantity of token X from the user address to the custodian address, based on the previous approval, e.g. by calling the transferFrom function of the ERC20 smart contract for token X, with the user address 112, custodian address 132a/132b and quantity as parameters—see operations 2a, 2b, 2c and 2d in FIG. 2A

These steps are repeated for each of the tokens transferred, using the respective smart contracts for those token types. This approach thus involves the user having to approve each token type separately for each target custodian entity.

Embodiments of the invention provide a delegate transaction model based on a delegate smart contract that enables transfers of different types of tokens to various target custodians to be managed by a single central entity. This is illustrated in FIG. 2C.

In this approach, the user transfers tokens to custody addresses through a delegate smart contract 200 acting as an intermediary. Specifically, the user approves the delegate contract once for each token type (step 1). The user then requests the delegate contract to transfer on their behalf (step 2). The delegate contract performs the transfer on behalf of the user (step 3). Since the approval is given by the user to the delegate contract, the delegate contract can make any number of transfers to different targets (e.g. target A and target B) without requiring separate approvals, as long as the transfers are within the configured allowance. The described approach can thus provide a delegate or proxy model of conventional token types such as ERC20 and ERC721.

Note that, while the present description refers to actions taken by a “user” in practice such steps (e.g. initiating token approval/transfer operations) would be performed by software acting on behalf of the user, for example a transaction processing application running on a user device. More generally, the user or entity acting on behalf of the user may also be referred to as the “client”.

The above approach can be extended to multi-token smart contracts that support transfer of multiple tokens of different types in a single transaction. For example, such a multi-token smart contract may be based on the ERC1155 multi-token standard, which supports both fungible and non-fungible tokens in accordance with the ERC20 and ERC721 token standards. An example is illustrated in FIG. 2D. Here, the initial approval step involves approving multiple tokens (Token A and Token B) using the ERC1155 batch approval function. In practice, there can be any number of tokens involved and these could be any mix of different token types (in this case ERC20 and ERC721 compatible token types), including any mix of fungible and non-fungible tokens. For fungible tokens (value tokens), the approval approves a specific token quantity as discussed above whereas for non-fungible tokens (unitary tokens), the approval is unitary (e.g. the approval quantity is exactly 1). The approval can in that case relate to a specific token (identified by a token ID) or to all tokens of that type held by the user.

After approval, the user can then instruct the delegate smart contract 200 to transfer multiple tokens of the supported types in a single operation. The delegate contract performs the transfer using a batch transfer function in accordance with the ERC1155 standard. Note that, as in the previous example, transfers can be made to various targets such as Target A and Target B without separate approvals for the different targets. Furthermore, any combination of supported token types can be transferred to any target, as long as the transfers specified in the ERC1155 transaction do not exceed the current approved limit for each token involved in the transaction (which may be the limit set in the initial approval or as subsequently modified by other transactions). This approach can thus significantly simplify transaction processing and reduce the number of blockchain operations (and hence blockchain transaction volume).

Multi-token bundles can include multiple fungible tokens (e.g. ERC20 tokens) and/or multiple non-fungible tokens (e.g. ERC721 tokens), in any combination.

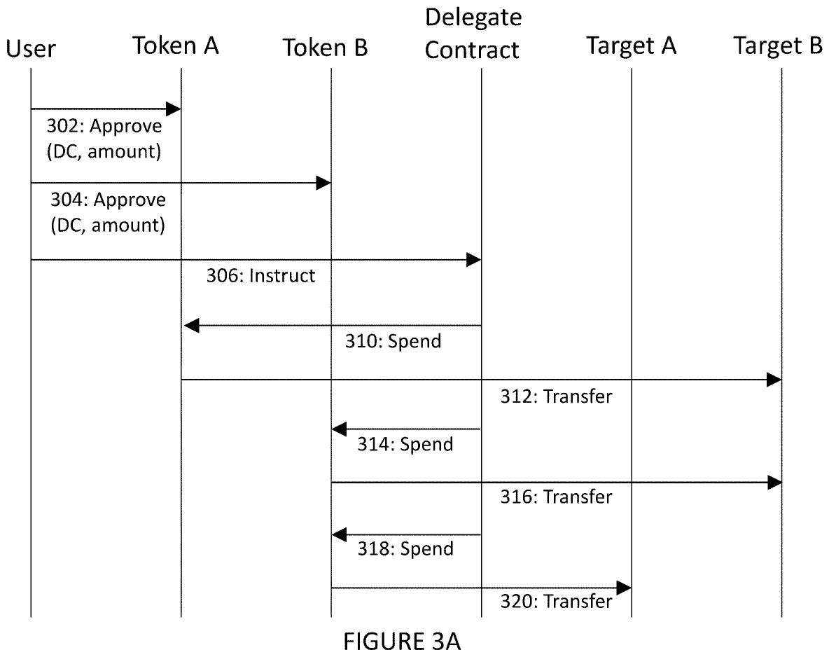

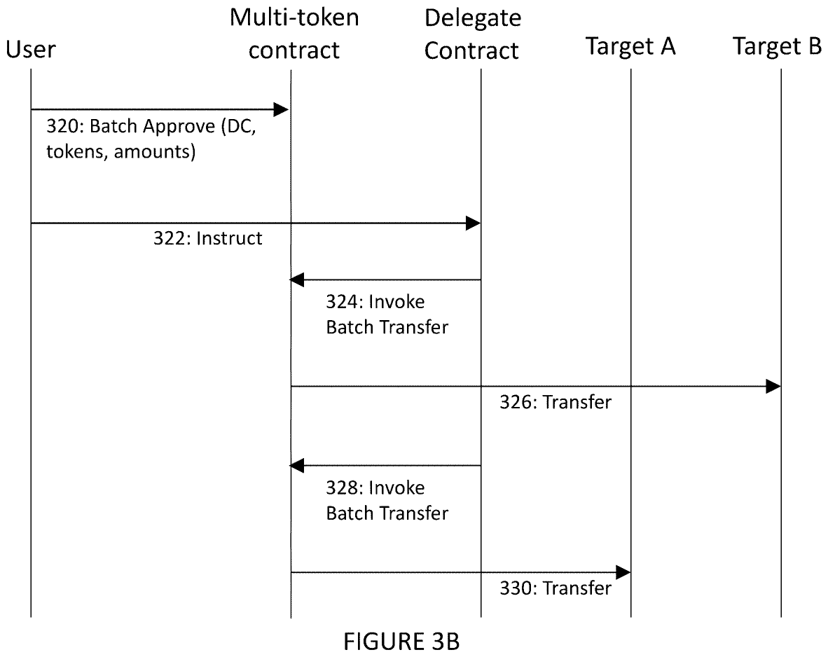

FIG. 3A illustrates a process flow for using the delegate contract to transfer tokens to multiple targets.

In step 302, the user invokes an approval function of the token contract for Token A specifying the address of the delegate smart contract (“DC”) as the approved entity and the approval amount (allowance). The user repeats this in step 304 for Token B (and indeed may repeat this step for any other tokens). In step 306, the user instructs the delegate contract to make transfers to various targets on the user's behalf, specifying the tokens, amounts and transfer targets. For example, the user may use a transaction user interface to request the transactions. The user may request multiple transactions at the same time or at different times. In this example, the user specifies transfers of both token types A and B to Target B and of token type B to Target A.

In step 310 the Delegate Contract invokes a transfer of Token A in the specified amount at the token contract for Token A, which then performs the token transfer in the specified amount to Target B (step 312). The Delegate Contract also invokes a transfer of Token B in the specified amount at the token contract for Token B (step 314), which performs the token transfer in the specified amount to Target B (step 316). Similarly, a transfer of token B to Target A is performed in steps 318-320. The same steps may be performed to perform transfers to other targets. Since the approval was granted to the delegate contract, no further approvals from the user are needed to perform such additional transfers.

The above process can be performed in the same way for multi-token batch transfers e.g. in accordance with the ERC1155 multi-token standard as illustrated in FIG. 3B. Here, the transfer involves the user calling the batch approval function of the multi-token contract, specifying the delegate contract (“DC”) as the approved entity and the approved tokens and corresponding token amounts for each token (step 320). The user then instructs the Delegate Contract to perform one or more batch transfers (322). These are then executed by the Delegate Contract. For example, the Delegate Contract invokes a batch transfer at the multi-token contract to transfer a set of token with specified transfer amounts (for fungible tokens) to target B in step 324 (executed by the multi-token contract in a batch transfer in step 326). The Delegate Contract performs a similar transfer to Target A in steps 328-330. As before, only the single approval operation 320 is needed regardless of the number of targets involved.

In preferred embodiments, the delegate contract may support various token contract types, including ERC20 and ERC721 token types and ERC1155 multi-token contracts. The delegate contract may also include other token types, including Ether.

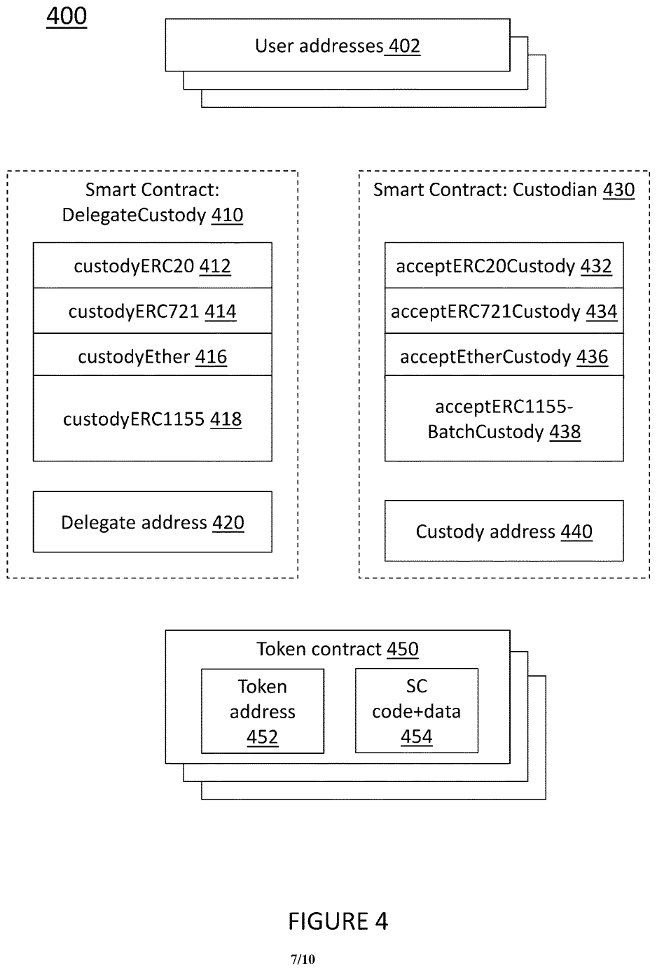

FIG. 4 illustrates elements of an example implementation of the above concepts on a blockchain 400. The blockchain is typically the Ethereum blockchain, but the principles may be adapted to any suitable blockchain implementation.

The blockchain 400 includes any number of user addresses 402 corresponding to users of the blockchain that may hold tokens. The tokens are managed by a set of token contracts 450. The blockchain may simultaneously support a variety of different types of tokens managed by respective token contracts and these may include multi-token contracts (e.g. ERC1155 compatible contracts). Each token contract 450 includes a token address 452 identifying the token contract and smart contract code (e.g. a set of functions) and data 454. A delegate smart contract 410, e.g. corresponding to smart contract 200 discussed above, here named “DelegateCustody”, implements the delegated transfer functions. A custodian smart contract 430 implements functions associated with a custodian (e.g. “Target A” or “Target B” in FIGS. 2-3). Thus, in this embodiment, custodians are represented by dedicated smart contracts rather than just a custodian address. The custody address 440 in this case is the address of the custodian smart contract.

The delegate contract 410 includes a set of “custody” functions for transferring custody of various classes of tokens to a custodian contract 430 identified by a custodian address 440. For example, the contract includes a custodyERC20 function 412 for transferring ERC20 compatible tokens, a custodyERC721 function 414 for transferring ERC721 compatible tokens (typically these are NFTs, non-fungible tokens) and a custodyEther function 416 for transferring Ether cryptocurrency.

Additionally a “custodyERC1155” function 418 is provided for transferring multi-token bundles in accordance with the ERC1155 multi-token standard. This function accepts a collection of multiple tokens and associated transfer amounts and transfers the amounts for the specified tokens to the custody address. The multiple tokens in a batch may include multiple tokens of the same type and/or tokens of different types. The token “type” here may correspond to the smart contract responsible for minting the token and processing transactions for the token. For example, a batch could include:
Multiple distinct ERC20 compatible tokens
Multiple distinct ERC721 compatible tokens.
A combination of one or more ERC20 token(s) and one or more ERC721 token(s)

The custodian smart contract includes a corresponding set of “accept” functions used to check whether particular token transfers can be accepted by the delegate smart contract, including an “acceptERC20Custody” function 432, “acceptERC721Custody” function 434, “acceptEtherCustody” function 436 and “acceptERC1155BatchCustody” function 438.

While ERC20, ERC721 and ERC1155 and Ether tokens are given by way of example, the custody smart contract may be extended to support any appropriate token types. Support for individual transfer of additional token classes (e.g. those not compatible with the identified token standards) may be added by way of additional individual custody functions in the delegate smart contract together with corresponding accept functions in the custody smart contracts.

Example definitions of the custody transfer functions are set out below.
1) custodyERC20 (address to, address token, uint amount) public;
2) custodyERC721 (address to, address token, uint tokenId, bytes memory data) public;
3) custodyERC1155 (address to, address token, uint[ ] calldata tokenIds, uint[ ] calldata values, bytes calldata data) public;
4) custodyEther (address to) external payable;

Here “to” is the custodian address, “token” is the address of the smart contract that manages the token to be transferred, “amount” is the value amount of the token to be transferred (in the case of value tokens/fungible tokens), and “tokenId” is the identifier of a specific unitary token to be transferred (in the case of a non-fungible token). In the ERC1155 example, arrays “tokenIds” of token identifiers and “values” of transfer values (e.g. this may be the transfer amount for fungible tokens or the value “1” for non-fungible tokens) are passed to the function.

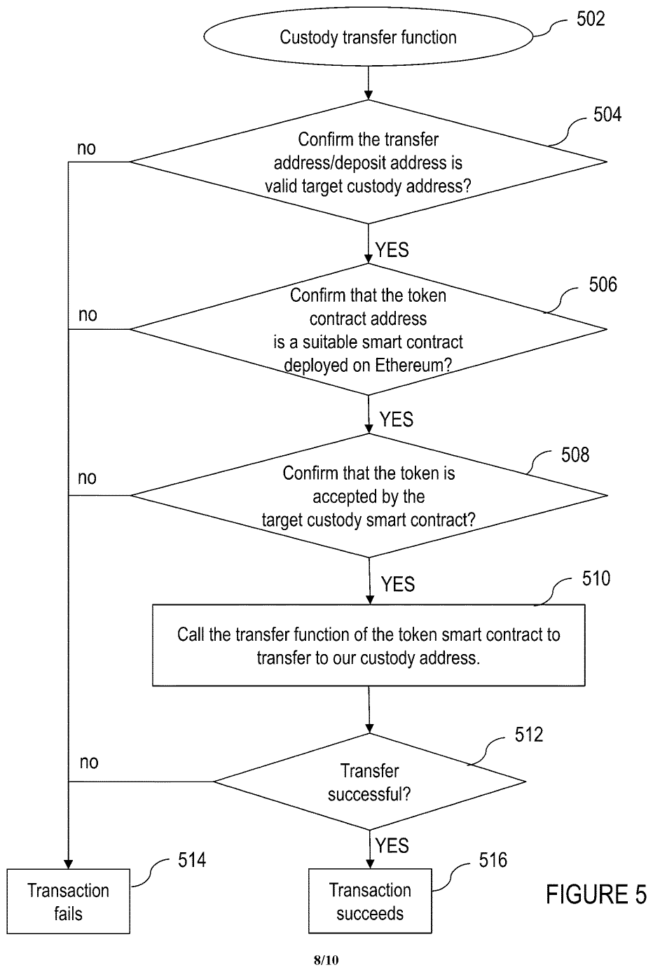

FIG. 5 illustrates processing performed by the custody transfer functions 412-418 in more detail.

In step 502, the custody transfer function is invoked. The inputs to the delegate transfer functions include the destination custodian address (address of the custody contract), address of the token smart contract (the contract managing the token or multi-token bundle), and a transfer amount (for fungible tokens) or token identifier (for non-fungible tokens). For example, for value tokens such as cryptocurrency tokens, a transfer operation may transfer a specified quantity of the token. The smart contract managing the token in that case manages user balances for the tokens under its control. For unitary asset tokens (e.g. non-fungible tokens), the token of the particular type is transferred as distinct, indivisible entity. In that case, the transfer amount may simply always be one (since there is only a single token of that type in existence). In that case, the managing smart contract transfers ownership of the token between users without maintaining variable user balances.

In step 504, the function checks whether the transfer destination address corresponds to a custody address associated with a custody smart contract. For example, the function may check the target address for the transfer is on a list of supported custody smart contracts. Alternatively, the function may merely check that the target address is a smart contract. If the check fails, then the process ends, with the transaction failed (514).

Otherwise, in step 506, the function checks whether the token address (the contract address of the contract managing the token) associated with the token to be transferred (or token bundle in case of multi-tokens) is a smart contract supporting the token that is deployed on the Ethereum blockchain. Additionally, the function checks in step 508 whether this token transfer is accepted by the custody smart contract (by calling the relevant “accept” function 432-428 of the custody contract 430, as discussed in more detail below). If both checks succeed, then processing proceeds to step 510. If either check fails, the processing ends, with the transaction failed (514).

In step 510, the function calls the transfer function of the smart contract that manages the token to transfer the token in the specified quantity to the custody address and determines (512) whether the transfer was successful. For example, the transfer might fail in case of an insufficient token quantity being available for transfer, or the transfer amount exceeding the amount approved for use by the delegate contract in the approval operation. If the transfer fails, then the process ends with the whole operation failed (514). If the transfer succeeds, then the operation as a whole succeeds (516) and processing ends.

Step 510 involves invoking the relevant external transfer function for the token in question at the token contract managing the token (specified by the “token” parameter provided to the delegate transfer function), for example the transferFrom function defined by the ERC20 standard for an ERC20 compatible token or similarly the ERC721 transferFrom or safeTransferFrom function for an ERC721 token.

In the case of the delegate transfer function 418 for multi-token bundles (e.g. ERC1155), step 510 involves calling the safeBatchTransferFrom function in accordance with the ERC1555 multi-token standard. This essentially performs a looped version of safe TransferFrom, in which the process loops over the tokens specified in the “tokenIds” array parameter, performing the necessary transfers in the amounts as specified in the “values” array parameter.

An example of the definition and operation of the custodyERC1155 batch transfer function is given by the following pseudocode:

```
Contract DelegateCustody {
  ......
  function custodyERC1155(address to, address token, uint[ ]
  calldata tokenIds, uint[ ] calldata values, bytes calldata data)
  public {
    // 1) check if “to” address is a custody contract address,
    if yes go next step, if no go to the end
    // 2) “to” address is the custody address, to which the
    user intends to send tokens. Here we need to check if “to”
    (custody) address can accept the token transfer by calling
    acceptERC1155BatchCustody at the custody contract. If yes,
    go next step, if no go to the end.
    // 3) using “token” address, call safeBatchTransferFrom
    function of ERC1155 standard smart contract.
    safeBatchTransferFrom is the batched version of
    safeTransferFrom. safeBatchTransferFrom transfers value
    tokens of type “tokenId” from msg. sender (i.e. the address
    of the user who invoked the custody function) to the “to”
    address. msg.sender (the user's address) must have a
    balance of tokens of type “tokenId” of at least “value”.
    // 4) End.
  }
  ......
}
```

As noted above, “safeBatchTransferFrom” is a looped version of “safeTransferFrom”. “safeTransferFrom” does not return anything, and so there is no need to check return values. However, the system may wait for emitted events, or implement the “afterTokenTransfer” functions which follow the standard of ERC1155.

As discussed above, the delegate contract's transfer functions perform various checks to confirm that the requested transfer is valid and capable of being performed. This includes a check (step 508 in FIG. 5) as to whether the token(s) in question can be accepted by the custody contract. In an embodiment, this check is performed by a set of interface functions (identified above and shown in FIG. 4 as the “accept” functions), as outlined in the following pseudocode. These functions (named acceptZZZCustody, where ZZZ is the token type) are used to control acceptance of custody service by the custody smart contract. Different functions are defined for different token standards, and each function returns a Boolean value indicating whether the custody contract can accept the given token type in the specified amount. The “acceptERC1155BatchCustody” variant performs a batched version for use in batched transfers of token bundles. Example definitions are set out below:

```
interface ERC20Receiver {
  // client - customer's address
  // token - token address
  // amount - custody value
  // check if custodian can accept “amount” tokens of “token”
  address from “client” address
  function acceptERC20Custody (address client, address token, uint
  amount) external returns (bool);
}
interface ERC721Receiver {
  // client - customer's address
  // token - token address
  // tokenId - ERC721 token id
  // check if custodian can accept “tokenId” token of “token”
  address from “client” address
  function acceptERC721Custody (address client, address token, uint
  tokenId) external returns (bool);
}
interface ERC1155Receiver {
  // a function to accept a bundle of ERC20 and/or ERC721 tokens in
a batch.
  // client - customer's address
  // to - to address
  // tokenIds - array of ERC1155 token ids
  // values - custody values
  // data - calldata, this is an encodeWithSelector in ABI
  (Application Binary Interface) format of Ethereum to call
  functions of other smart contracts.
  check if custodian can accept “values” tokens of type “tokenid”
  from “client” address to “to” address
  function acceptERC1155BatchCustody (address client, address to,
  uint[ ] calldata tokenIds, uint[ ] calldata values, bytes calldata
  data) external returns (bool);
}
interface EtherReceiver {
  // client - customer's address
  // amount - transfer amount
  check if custodian can accept “amount” ETHER from “client”
address
  function acceptEtherCustody (address client, uint amount)
  external returns (bool);
}
```

The “accept” functions may make the determination based on criteria such as thus originating user address (“client”), the transfer amount, the type of token etc. and may use any combination of such criteria. If the specified transfer does not meet the acceptance criteria, a “False” result is returned, resulting in failure of the transaction at the corresponding delegate function in delegate contract 410. Otherwise a “True” result is returned, allowing the transaction to proceed (see step 508 of FIG. 5).

While described in relation to the Ethereum blockchain and more particularly certain classes of Ethereum tokens (e.g. ERC20, ERC721), the described techniques can also be used with other token types and/or other Ethereum Virtual Machine (EVM) based blockchains and other smart contract blockchains.

The described process for custody transfer can improve transaction processing efficiency. From the perspective of the client, only a single “approve” operation needs to be performed to allow transfers of tokens to any number of custodian entities. When using the ERC1155 multi-token transfer, only a single approval call and a single transfer transaction needs to be performed to transfer multiple tokens, reducing transaction overheads and hence cost (e.g. in terms of computational cost and/or Ether/gas transaction cost). For example, since each transaction has a metadata envelope, combining transactions can reduce processing cost.

Furthermore, by grouping the transactions in a batch via the multi-token transfer, this approach improves the likelihood that the transactions in the batch will be performed within a single block period and hence will be included in the same block of the blockchain. This improves transaction throughput and security since the user does not have to wait multiple block periods for completion of the batch transfer (with the potential for the batch transfer being stalled due to delays in processing one or more of the blocks). This also means that subsequent transactions (e.g. to withdraw/transfer tokens) can proceed immediately.

A custodian in the above scenarios may, for example, be a cryptocurrency wallet service, trading service or other cryptocurrency, NFT, or token-based service.

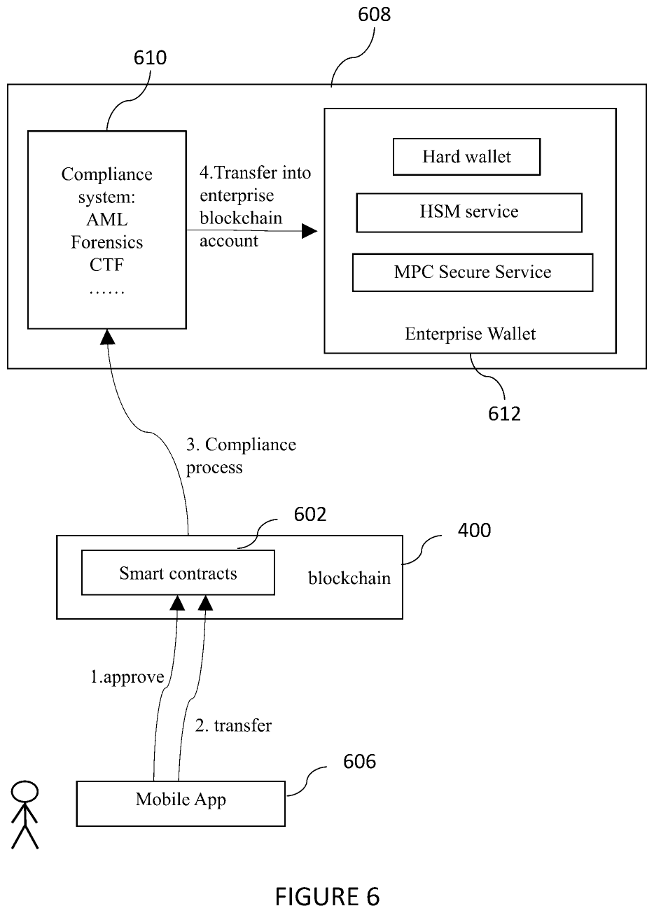

FIG. 6 illustrates the architecture of a custody system incorporating the delegate smart contract as described above.

The custody system includes the blockchain 400, implemented by a set of network-connected blockchain nodes. In the present examples this is the Ethereum blockchain but the invention is not limited thereto. The various smart contracts 602, including token contracts, delegate contract and custody contracts, are deployed on the blockchain at given addresses (corresponding to the token, delegate and custody addresses discussed above). In preferred embodiments, the delegate smart contract may not be upgradeable to ensure that the contract itself cannot change and can thus be trusted by system users. The delegate and custody smart contracts implement the various functions for token transfer as described above.

An enterprise system 608 is responsible for the enterprise's custody business. It includes an enterprise compliance system 610 and an enterprise wallet 612. The enterprise compliance system is responsible for a compliance process, including, for example, anti-money laundering, criminal investigation, and anti-terrorist financing. This module performs inspection to check whether token assets are compliant. The enterprise wallet system 612 supports enterprise-side storage of token assets. Modules that the enterprise wallet system may use include a hard wallet, hardware security module (HSM) cloud service, and/or a multi-party computing (MPC) security service. Hard wallets directly help enterprises and users manage user private keys offline. The HSM cloud service helps enterprises and users to obtain private keys and complete signatures. The MPC security service helps enterprises and users complete transfer transactions after completing the signature of the individual private key in multi-user applications.

A mobile app 606 is provided on a user device (e.g. personal computer, smartphone etc). As discussed above, transactions require users to approve access to token assets by the delegate contract. For example, regardless of whether ERC20, ERC721, or ERC1155 type tokens are used, they need to be approved before transferring token assets to the custody token contract account, that is, the approval of the contract needs to be done before the transfer. Approval can be managed by the mobile app. After approval, the mobile app can be used to instruct the delegate contract to perform specific transfers in accordance with the prior approvals.

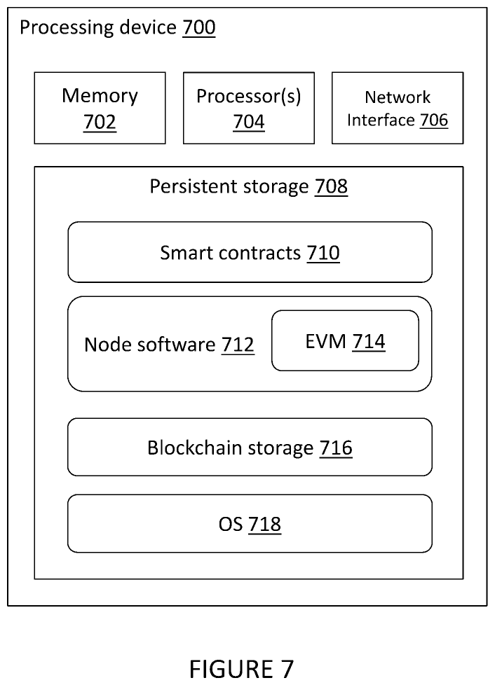

FIG. 7 illustrates an example of a processing device 700, such as a server, that may be used to implement the described techniques. The processing device may operate as a node of the Ethereum blockchain.

The processing device includes one or more processors 704 together with volatile/random access memory 702 for storing temporary data and software code being executed. A network interface 706 is provided for communication with other system components, such as other blockchain nodes, over one or more networks (e.g. Local and/or Wide Area Networks, including the Internet).

Persistent storage 708 (e.g. in the form of hard disk storage, solid state storage and the like) persistently stores software and data for performing the described functions of the custody system. This includes an operating system 718 together with blockchain node software 712 for configuring the processing device to operate as a node of the Ethereum blockchain. This includes the EVM (Ethereum Virtual Machine) 714 for running Ethereum smart contracts 710, such as the token, delegate and custody smart contracts discussed above. The persistent storage also includes blockchain storage 716 for storing a local copy of some or all of the blockchain.

The processing device will include other conventional hardware components as known to those skilled in the art, and the components are interconnected by one or more data buses (e.g. a memory bus and I/O bus).

While a specific architecture is shown and described by way of example, any appropriate hardware/software architecture may be employed to implement the custody system.

Furthermore, functional components indicated as separate may be combined and vice versa.

It will be understood that the present invention has been described above purely by way of example, and modification of detail can be made within the scope of the invention.

1. A blockchain transaction system for transferring blockchain tokens from source addresses to custodian entities, provided on a blockchain that implements one or more token smart contracts for managing one or more token types, the system comprising:
a delegate smart contract implemented on the blockchain identified by a delegate address, and comprising one or more delegate transfer functions for transferring tokens from a source address to custodian entities;
a plurality of custody smart contracts implemented on the blockchain, each custody smart contract corresponding to a custodian entity and identified by a custodian address;
wherein the delegate smart contract is configured to process, using a delegate transfer function, a plurality of transfer requests to transfer custody of tokens of the given token type from a source address associated with a token holder to respective different custodian entities specified by respective custodian addresses; and
wherein the plurality of transfers are performed in accordance with an approval configured at the token smart contract associated with the given token type, the approval granting token transfer approval by the source address to the delegate address associated with the delegate smart contract.

2. A system according to claim 1, wherein the system is configured to process, by the token smart contract for the given token type, an approval request for the given token type, the approval request specifying the source address of the token holder and the delegate address for the delegate smart contract as the approved address.

3. A system according to claim 1, wherein the delegate smart contract is configured to process a plurality of requests to transfer custody of tokens of a second token type from the source address to respective custodian entities associated with respective custodian addresses based on a second token transfer approval granted to the delegate address for the delegate smart contract by the source address.

4. A system according to claim 1, wherein the, or each, token transfer approval specifies an approved token quantity or one or more approved token identifiers.

5. A system according to claim 1, wherein the delegate transfer function is configured, for each transfer, to invoke a transfer function of the token smart contract for the given token type to perform the transfer to the respective custodian address.

6. A system according to claim 1, wherein tokens being transferred comprise one or more of:
a fungible or value token, wherein a transfer of a fungible or value token is associated with a value quantity of the token to be transferred;
a non-fungible or unitary token, wherein a transfer of a non-fungible or unitary token is associated with a token identifier of a token to be transferred; and
a multi-token bundle comprising a plurality of fungible and/or non-fungible tokens.

7. A system according to claim 1, wherein the given token type is a multi-token bundle, each transfer request specifying a plurality of tokens or token values to be transferred to a respective custodian address in a batch transfer.

8. A system according to claim 7, wherein the delegate smart contract is configured to invoke a batch transfer function of the token smart contract for the token bundle.

9. A system according to claim 6, wherein the multi-token bundle is an ERC1155 token bundle.

10. A system according to claim 1, wherein the delegate smart contract comprises a plurality of delegate transfer functions, each supporting transfer of a respective class of tokens.

11. A system according to claim 10, wherein one or more of the delegate transfer functions process transfers of tokens of a respective token standard.

12. A system according to claim 11, comprising respective delegate transfer functions for one or more of:
ERC20 compatible tokens;
ERC721 compatible tokens;
ERC1155 compatible token bundles;
Ether tokens.

13. A system according to claim 1, wherein the delegate transfer function is configured, for each transfer to a respective custodian address, to query the custodian smart contract at the custodian address to determine whether the custodian smart contract can accept the transfer, and to perform the transfer in dependence on the determination.

14. A system according to claim 13, wherein the custodian smart contract is configured to determine whether the transfer can be accepted based on one or more of: the token type, a transfer value; and/or the source address for the transfer; and to return a query response indicating the determination.

15. A system according to claim 14, wherein the custodian smart contract comprises one or more acceptance functions, each acceptance function configured to:
receive a query specifying one or more parameters including one or more of: a source address, a token contract address, and a transfer value;
determine whether the transfer can be accepted based on the one or more parameters; and
return a determination result.

16. A system according to claim 15, wherein each custodian contract includes respective acceptance functions for one or more of:
ERC20 compatible tokens;
ERC721 compatible tokens;
ERC1155 compatible token bundles; and
Ether tokens.

17. A system according to claim 1, wherein the delegate transfer function is configured to check that the custodian address specified for a transfer corresponds to a smart contract on the blockchain and/or corresponds to one of a set of predetermined custodian contracts, and to perform the transfer to the custodian address only in response to a positive determination.

18. A method of performing transactions comprising:
receiving, by a delegate smart contract of the blockchain, a request to transfer custody of one or more token assets from a source address to a custodian entity;
querying, by the delegate smart contract, a custody smart contract associated with the custodian entity to determine if the transfer can be accepted by the custody smart contract; and
invoking, by the delegate smart contract, in response to determining that the transfer can be accepted, a transfer function of a token contract associated with the one or more token assets to transfer the one or more token assets to the custodian entity.

19. A method according to claim 18, wherein the one or more token assets comprise one or more of:
at least one token amount of a value token or fungible token;
at least one unitary or non-fungible token;
a bundle of value tokens and/or unitary tokens.

20-25. (canceled)

26. A non-transitory computer readable medium storing computer interpretable instructions, which when executed by a processor, cause the processor to perform a method of performing transactions comprising:
receiving, by a delegate smart contract of the blockchain, a request to transfer custody of one or more token assets from a source address to a custodian entity;
querying, by the delegate smart contract, a custody smart contract associated with the custodian entity to determine if the transfer can be accepted by the custody smart contract; and invoking, by the delegate smart contract, in response to determining that the transfer can be accepted, a transfer function of a token contract associated with the one or more token assets to transfer the one or more token assets to the custodian entity.
